(19) United States
(12) Patent Application Publication
(10) Pub. No.: US 2025/0307340 A1
(43) Pub. Date: Oct. 2, 2025

(54) COMPUTER-BASED SYSTEMS CONFIGURED FOR FEATURE ENGINEERING WITH TARGET-DRIVEN DIMENSIONALITY REDUCTIONS AND METHODS OF USE THEREOF

(71) Applicant: Capital One Services, LLC, McLean, VA (US)

(72) Inventor: Michael Langford, Plano, TX (US)

(21) Appl. No.: 18/617,153

(22) Filed: Mar. 26, 2024

(51) Int. Cl. G06F 17/11

(52) U.S. Cl. CPC G06F 17/11

(57) ABSTRACT

In some embodiments, an exemplary method may include receiving a first dataset having a first plurality of features, performing a deep feature synthesis to synthesize a second plurality of features from the first plurality of features, separating the first plurality of features from the second plurality of features to form a third plurality of features, generating a second dataset based on the third plurality of features, running a plurality of dimensionality reductions on the second dataset to generate a plurality of reduced datasets, wherein each dimensionality reduction produces a different dimension less than a dimension of the second dataset, calculating an explained variance (EV) of each of the plurality of reduced datasets to generate a plurality of EVs, identifying a particular EV from the plurality of EVs that is a smallest EV above a threshold, and selecting a particular reduced dataset corresponding to the particular EV as a target dataset.

### FIELD OF TECHNOLOGY

The present disclosure generally relates to computer-based systems configured for feature engineering with target-driven dimensionality reductions and methods of use thereof.

### BACKGROUND OF TECHNOLOGY

In data science, typically, data may be structured and relational, usually presented as a set of tables with relational links. Typically, the data may capture some aspect of human interactions with a complex system. Typically, the data science may attempt to predict some aspect of human behavior, decisions, and/or activities (e.g., to predict whether a person would perform a certain activity).

In some instances, there may be a prediction problem formulated, in response to which a data scientist may first form variables, otherwise known as features or data features. In some instances, the data scientist may start by using some static fields (e.g. gender, age, etc.) from the tables as existing features, then synthesize new features (e.g. “percentile of a certain feature”) from the existing features. In some instances, the process for extracting these numeric features may be called “feature engineering” herein.

### SUMMARY OF DESCRIBED SUBJECT MATTER

In some embodiments, the present disclosure may provide an exemplary technically improved computer-based method that may include receiving a first dataset having a first plurality of features; performing, by the at least one computing device, a deep feature synthesis to synthesize a second plurality of features from the first plurality of features; separating, by the at least one computing device, the first plurality of features from the second plurality of features to form a third plurality of features; generating, by the at least one computing device, a second dataset based on the third plurality of features; running, by the at least one computing device, a plurality of dimensionality reductions on the second dataset to generate a plurality of reduced datasets, where each dimensionality reduction produces a different dimension less than a dimension of the second dataset; calculating, by the at least one computing device, an explained variance (EV) of each of the plurality of reduced datasets to generate a plurality of EVs; identifying, by the at least one computing device, at least one particular EV from the plurality of EVs based on a predetermined EV threshold (EVT); and selecting, by the at least one computing device, a particular reduced dataset from the plurality of the reduced datasets as a target dataset, the particular reduced dataset corresponding to the at least one particular identified EV.

In some embodiments, the deep feature synthesis may include direct features applied over forward relationships. The deep feature synthesis includes recursive syntheses of synthesized features.

In some embodiments, each of the plurality of dimensionality reductions may project the second dataset onto a dimensional space with a dimension lower than a dimension of the second dataset.

In some embodiments, the plurality of dimensionality reductions are run with a linear discriminant analysis (LDA) model.

In some embodiments, the method further includes sorting the plurality of EVs in a sequential order, and identifying the at least one particular EV by a binary search on the plurality of sorted EVs.

In some embodiments, the at least one particular EV is a smallest EV that is above the predetermined EVT.

In some embodiments, each of the plurality of dimensionality reductions is run in a separate computing node of a computing device.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram illustrating feature engineering with deep feature synthesis and dimensionality reduction in accordance with one or more embodiments of the present disclosure.

FIG. 2 is a block diagram illustrating an exemplary deep feature synthesis in accordance with one or more embodiments of the present disclosure.

FIG. 3 is a flowchart illustrating an exemplary computer-based feature engineering process including feature synthesis and dimensionality reductions in accordance with one or more embodiments of the present disclosure.

FIGS. 4A and 4B illustrate an effect of linear discriminant analysis performed on two classes of data in accordance with one or more embodiments of the present disclosure.

FIG. 5 illustrates a binary search algorithm for identify an explained variance just above a user provided explained variance threshold in accordance with one or more embodiments of the present disclosure.

FIG. 6 is a block diagram of an exemplary computing system that may implement the methods described herein.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

In some instances, machine learning algorithms may rely on numerical data to make predictions. In some instances, the numerical data may be composed of relevant features. The embodiments disclosed herein provide technical solutions and technical improvements that overcome technical problems, drawbacks and/or deficiencies in the technical fields arising, for example, without limitation, when the calculated features don't expose the predictive signals in sufficient extent that may make challenging to train a model to increase its predictive quality.

As explained in more detail, herein, technical solutions and technical improvements herein include aspects of deep feature synthesis and performing target-driven dimensionality reduction on the synthesized features. Based on such technical features, further technical benefits become available to users and operators of these systems and methods. Moreover, various practical applications of the disclosed technology are also described, which provide further practical benefits to users and operators that are also new and useful improvements in the art.

In at least some embodiments or in combination of at least one other embodiment described herein, the present disclosure is directed to dimensionality reduction of a dataset with large number of synthesized features. In at least some embodiments or in combination of at least one other embodiment described herein, the present disclosure describes at least one illustrative method, without limitation, which may include receiving a first dataset having a first plurality of features, performing a deep feature synthesis to synthesize a second plurality of features from the first plurality of features, separating the first plurality of features from the second plurality of features to form a third plurality of features, generating a second dataset based on the third plurality of features, running a plurality of dimensionality reductions on the second dataset to generate a plurality of reduced datasets, wherein each dimensionality reduction produces a different dimension less than a dimension of the second dataset, calculating an explained variance (EV) of each of the plurality of reduced datasets to generate a plurality of EVs, identifying a particular EV from the plurality of EVs that is a smallest EV above a predetermined EV threshold (EVT), and selecting a particular reduced dataset corresponding to the particular EV as a target dataset.

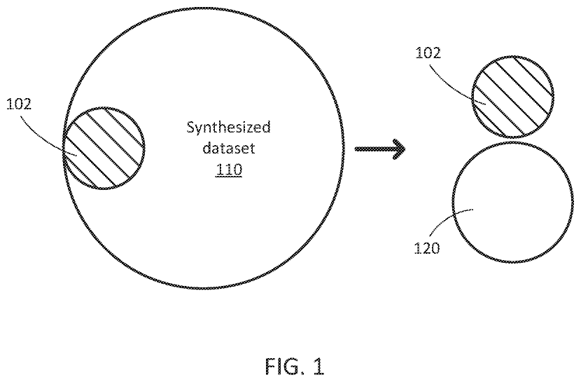

FIG. 1 is a block diagram illustrating feature engineering with deep feature synthesis and dimensionality reduction in accordance with one or more embodiments of the present disclosure. In at least some embodiments or in combination of at least one other embodiment described herein, the feature engineering may be performed on dataset 102 that may be inputted by a user. In an embodiment, dataset 102 may be tabular binary classified with a target class variable identified. In at least some embodiments or in combination of at least one other embodiment described herein, features contained in dataset 102 are existing features.

Dataset 102 may then be provided to an exemplary deep feature synthesis (DFS) to generate synthesized dataset 110. The exemplary DFS of the present disclosure may be configured to facilitate determining new important synthetic features from an existing dataset by applying feature transformations in successive rounds. However, discovering important new features through this process can be difficult as thousands or millions of new features can be created.

In at least some embodiments or in combination of at least one other embodiment described herein, the DFS uses all feature transformations on all existing features. Additionally, user can input additionally feature transformations to be included in the DFS. Therefore, synthesized dataset 110 can have thousands, millions, billions, or another large number of new features. Such large number of new features may render discovering important new features difficult and processing them may take huge amount of computing resources. In response, the present disclosure provides systems and methods to reduce the number of features (dimensionality reduction) in synthesized dataset 110 to smaller dataset 120 with fewer but important features.

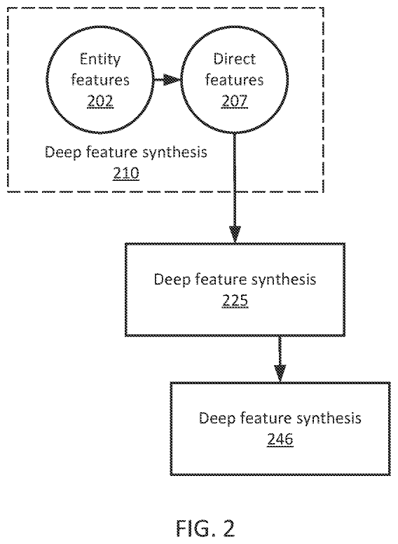

FIG. 2 is a block diagram illustrating an exemplary deep feature synthesis for generating synthesized dataset 110 shown in FIG. 1. Existing features may be first translated to an entity features 202. In at least some embodiments or in combination of at least one other embodiment described herein, the exemplary deep feature synthesis may include one or more functions that translate an existing feature in an entity table into another type of value, like conversion of a categorical string data type to a pre-decided unique numeric value or rounding of a numerical value. Other examples may include, without limitation, a translation of a timestamp into four distinct features-weekday (1-7), day of the month (1-30/31), month of the year (1-12) or hour of the day (1-24).

In an e-commerce example, Orders entity has a forward relationship with Customers; that is, each order in the Orders table is related to only one customer.

Referring again to FIG. 2, direct features 207 are applied over the forward relationships. Entity features 202 and direct features 207 form one sequence of deep feature synthesis 210 which can be used recursively. For example, direct features 207 can be used in another sequence of deep feature synthesis 225 to generate new features.

Some examples are polynomial functions applied to each row (like x\hat{ }2), taking the sine or cosine of a column, or pulling the day or month out of a timestamp column. Multiple columns may also be added, multiplied, divided, or otherwise created a linear or nonlinear combination. Since these are naturally applied to each row in a column (or columns) and return a column with the same number of rows, these operations can be chained together seamlessly.

As shown in FIG. 2, the recursive generating scheme may be further performed in deep feature synthesis 246. The recursion may terminate when a certain depth is reached or there are no related entities. In such a way, the exemplary feature space that may be enumerated by deep feature synthesis grows very quickly.

In at least some embodiments or in combination of at least one other embodiment described herein, the exemplary deep feature synthesis may utilize dimensionality reduction, by reducing the number of features (or dimensions) in a dataset while retaining as much information as possible. In at least some embodiments or in combination of at least one other embodiment described herein, the exemplary deep feature synthesis may be done for a variety of reasons, such as to reduce the complexity of a model, to improve the performance of a learning algorithm, and/or to make it easier to visualize the data. In at least some embodiments or in combination of at least one other embodiment described herein, the exemplary deep feature synthesis may utilize one or more techniques for dimensionality reduction, including principal component analysis (PCA), singular value decomposition (SVD), and/or linear discriminant analysis (LDA). In at least some embodiments or in combination of at least one other embodiment described herein, at least one dimensionality reduction technique may be configured to use a different method to project the data onto a lower dimensional space while preserving important information.

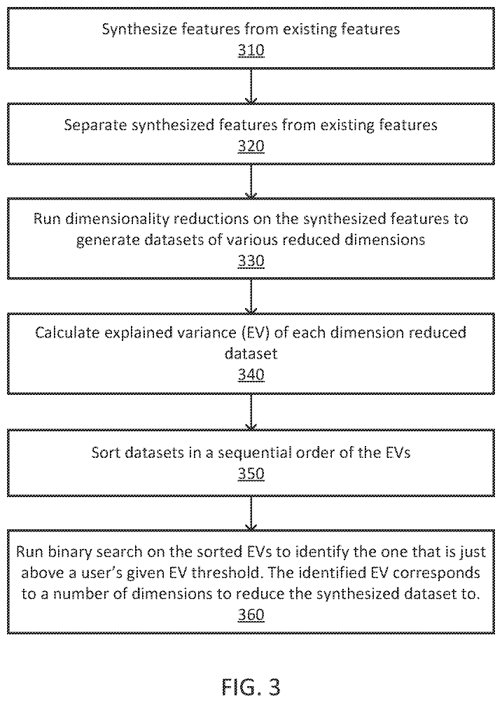

FIG. 3 is a flowchart illustrating a computer-based feature engineering process including feature synthesis and dimensionality reductions in accordance with one or more embodiments of the present disclosure. In at least some embodiments or in combination of at least one other embodiment described herein, an exemplary feature engineering process may begin with synthesizing features from existing features in block 310. The existing features are received from a user intending to discover new features beyond the existing features. In block 320, the synthesized features are separated from the existing features in preparation for dimensionality reductions performed in block 330, as only the number of synthesized features need to be reduced. In block 330, multiple rounds of dimensionality reductions with different parameters result in multiple datasets with different dimensions (number of features). In block 340, an explained variance (EV) of each dimension-reduced dataset is calculated. Here, in at least one non-limiting example, the explained variance may refer to a variance in the response variable in a model that can be explained by the predictor variable(s) in the model. The higher the explained variance of a model, the more the model is able to explain the variation in the data. Value of the explained variance may vary between 0 and 1. “0” means that the model cannot explain the variation in the data; and “1” means that the model can entirely explain the variation in the data. In at least some embodiments, or in combination with at least one other embodiment, the explained variance may be used to measure a discrepancy between a model and actual data as the part of the model's total variance that may be explained by factors that are actually present and may not be due to error variance. In at least some embodiments, or in combination with at least one other embodiment, Higher percentages of explained variance such as 0.9, indicate a stronger strength of association. It also means that the model can make better predictions. For these dimension-reduced datasets, the higher the dimension, the higher their explained variance.

Referring again to FIG. 3, in block 350, the datasets are sorted in a sequential order of the calculated EVs. In block 360, binary search is exemplarily run on the sorted EVs to identify a particular EV that is just above a user predetermined EV threshold (EVT). In other words, the particular EV is a smallest EV that is above the EVT. To illustrate, assume values of a plurality of EVs are 3, 4, 5 and 6, respectively, and an EVT is 4.5, then the particular EV that is just above the EVT has a value of 5. Here, the EVT serves as a target for the dimensionality reduction.

The particular EV corresponds to a number of dimensions to reduce the synthesized dataset to. Therefore, a target dataset has the smallest dimension that can satisfied the user provided EV threshold.

In some embodiments, the above dimensionality reductions are performed with linear discriminant analysis (LDA). LDA algorithms model the data distribution for each class and use Bayes' theorem to classify new data points. Bayes calculates conditional probabilities—the probability by using Bayes to calculate the probability of whether an input dataset will belong to a particular output.

The LDA works by identifying a linear combination of features that separates or characterizes two or more classes of objects or events. The LDA does this by projecting data with two or more dimensions into one dimension so that it can be more easily classified.

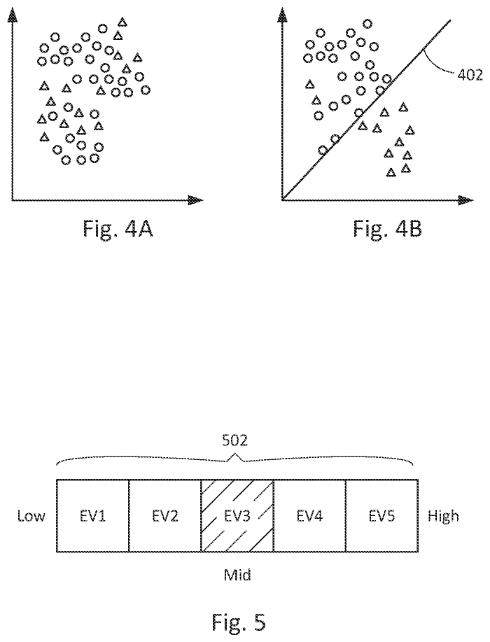

FIGS. 4A and 4B show an effect of LDA performed on two classes or features of data represented by circular and triangular dots. For example, suppose that a bank is deciding whether to approve or reject loan applications. The bank uses two features to make this decision: the applicant's credit score (represented by circular dots) and annual income (represented by triangular dots).

FIG. 4A shows that the two features or classes are plotted on a 2-dimensional (2D) plane with an X-Y axis. If a goal is to try to classify approvals using just one feature (dimensionality reduction), overlap may be observed.

FIG. 4B shows that by applying LDA, a straight line 402 is drawn that separates these two class data points. The LDA achieves this by using the X-Y axis to create a new axis, separating the different classes with a straight line and projecting data onto the new axis.

To create this new axis and reduce dimensionality, the LDA follows these criteria:
Maximize the distance between the means of two classes; and
Minimize the variance within individual classes.

In general, LDAs operate by projecting a feature space, that is, a dataset with n-dimensions, onto a smaller space “k”, where k is less than or equal to n−1, without losing class information. An LDA model includes the statistical properties that are calculated for the data in each class. When there are multiple features or variables, these properties are calculated over the multivariate Gaussian distribution.

The multivariate is defined as: means; and covariance matrix, which measures how each variable or feature relates to others within the class.

The statistical properties that are estimated from the dataset are fed into the LDA function to make predictions and create the LDA model. There are some constraints as the model assumes the following:
The input dataset has a Gaussian distribution, where plotting the data points gives a bell-shaped curve.
The data set is linearly separable, meaning LDA can draw a straight line or a decision boundary that separates the data points.
Each class has the same covariance matrix.

Dimensionality reduction involves separating data points with a straight line. Mathematically, linear transformations are analyzed using eigenvectors and eigenvalues. Imagine a dataset is mapped out with multiple features, resulting in a multi-dimensional scatterplot. Eigenvectors provide the “direction” within the scatterplot. Eigenvalues denote the importance of this directional data. A high eigenvalue means the associated eigenvector is more critical.

During dimensionality reduction, the eigenvectors are calculated from the dataset and collected in two scatter-matrices:
Between-class scatter matrix (information about the data spread within each class).
Within-class scatter matrix (how classes are spread between themselves).

The presence of variance is very important in a dataset because this allows the model to learn about the different patterns hidden in the data. The present disclose describes a way that maximizes the variance while reducing dimensionality by using an explained variance threshold.

In at least some embodiments or in combination with at least one other embodiment, Explained variance (EV) may measure how well a model accounts for the variation in a dataset. In at least some embodiments or in combination with at least one other embodiment, EV may be expressed as a percentage or a fraction of the total variation. For example, if a model explains 80% of the variation, then the remaining 20% is unexplained or due to error.

In at least some embodiments or in combination with at least one other embodiment, Explained variance can be represented as a function of ratio of related eigenvalue and sum of eigenvalues of all eigenvectors. Assume that there are N eigenvectors, then the explained variance for each eigenvector (principal component) can be expressed by the ratio of eigenvalue of related eigenvalue λᵢ and sum of all eigenvalues (λ₁+λ₂+. . . +λₙ) as the following:

$$\frac{{λ}_{i}}{{λ}_{1} + {λ}_{2} + … + {λ}_{n}} \qquad ( Eq . 1 )$$

Referring again to FIG. 3, the dimensionality reductions of the present disclosure generate a plurality of datasets with various reduced dimensions in block 330. In order to identify a dataset with a right dimension having an explained variance just above a user given explained variance threshold (EVT), the datasets are sorted in a sequential order of the explained variances in block 350. Then a binary search on the sorted explained variances against the user provided EVT is conducted in block 360.

FIG. 5 illustrates a binary search algorithm for identify an explained variance just above a user provided explained variance threshold. An exemplary search space 502 includes five explained variances, EV1-EV5, which are sorted in a sequentially ascending order. A first step is to divide search space 502 into two halves by finding a middle index “mid”: mid=low+(high−low)/2.

A second step is to compare the middle element (EV3) of search space 502 with the user provided EVT. If the user provided EVT is found at middle element, the process is terminated. If the EVT is not found at middle element, choose which half will be used as the next search space. If the EVT is smaller than the middle element, then the left side is used for next search. If the EVT is larger than the middle element, then the right side is used for next search. This process is continued until the EVT is found or search space 502 is exhausted.

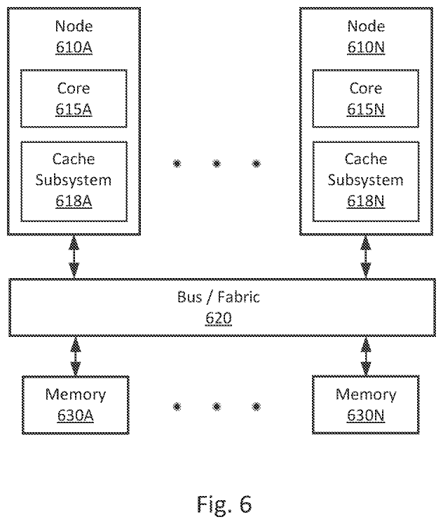

FIG. 6 is a block diagram of an exemplary computing system that implements the methods described herein. The computing system includes multiple nodes 610A-N for performing one or more computing tasks, with the number of nodes per system varying from implementation to implementation. Each node 610A-N can include any number of cores 615A-N, respectively, with the number of cores varying according to the implementation and from node to node. Each core 615A-N includes at least one computing device, such as a CPU and/or GPU (not shown). Each node 610A-N also includes a corresponding cache subsystem 618A-N, respectively. Each cache subsystem 618A-N can include any number of cache levels and any type of cache hierarchical structure. In an implementation, cache subsystem 618A is locally accessible by core 615A as well as accessible by other nodes 610B (not shown)-110N through a bus/fabric 620.

In one embodiment, each node 610A-N is coupled to a corresponding memory 630A-N, respectively, through the bus/fabric 620. In an implementation, contents stored in memory 630A-N are first loaded to cache subsystem 618A-N for execution by core 615A-N. Each memory 630A-N is accessible by any one of node 610A-N. Many other devices or subsystems can be connected to the computing system shown in FIG. 6.

The computing system can also employ any number of software, firmware, and/or hardware configurations. For example, one or more of the example embodiments disclosed herein can be encoded as a computer program (also referred to as computer software, software applications, computer-readable instructions, and/or computer control logic) on a computer-readable medium.

The term “computer-readable medium,” as used herein, can generally refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

One of the example embodiments can be the deep feature synthesis shown in FIG. 2. In order to increase processing efficiency, multiple syntheses can be simultaneously performed by nodes 610A-N separately. For example, deep feature synthesis 222 is performed by node 610A while deep feature synthesis 225 is performed by node 610N.

Another one of the example embodiments can be the dimensionality reductions shown in FIG. 3. The synthesized features can be simultaneously provided to multiple nodes 610A-N each running a dimensionality reduction model. Different nodes generate datasets of different dimensions. Such parallel dimensionality reductions can reduce overall compute time.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment may be implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD, NetBSD, OpenBSD; (2) Linux; (3) Microsoft Windows; (4) OS X (MacOS); (5) MacOS 11; (6) Solaris; (7) Android; (8) iOS; (9) Embedded Linux; (10) Tizen; (11) WebOS; (12) IBM i; (13) IBM AIX; (14) Binary Runtime Environment for Wireless (BREW); (15) Cocoa (API); (16) Cocoa Touch; (17) Java Platforms; (18) JavaFX; (19) JavaFX Mobile; (20) Microsoft DirectX; (21) .NET Framework; (22) Silverlight; (23) Open Web Platform; (24) Oracle Database; (25) Qt; (26) Eclipse Rich Client Platform; (27) SAP NetWeaver; (28) Smartface; and/or (29) Windows Runtime.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the exemplary inventive computer-based systems/platforms, the exemplary inventive computer-based devices, and/or the exemplary inventive computer-based components of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTRO, SHA-1, SHA-2, Tiger (TTH), WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications for implementing the functions of the CVCP as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

In some embodiments, exemplary inventive computer-based systems/platforms, exemplary inventive computer-based devices, and/or exemplary inventive computer-based components of the present disclosure may be configured to handle numerous concurrent users via the N user devices that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

The aforementioned examples are, of course, illustrative and not restrictive.

In some embodiments, the exemplary inventive computer-based systems/platforms, the exemplary inventive computer-based devices, and/or the exemplary inventive computer-based components of the present disclosure may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node may be activated. In some embodiments and, optionally, in combination of any embodiment described above or below, the exemplary aggregation function may be a mathematical function that combines (e.g., sum, product, etc.) input signals to the node.

In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

At least some aspects of the present disclosure will now be described with reference to the following numbered clauses.

Clause 1. A computer-based method, including: receiving, by at least one computing device, a first dataset having a first plurality of features; performing, by the at least one computing device, a deep feature synthesis to synthesize a second plurality of features from the first plurality of features; separating, by the at least one computing device, the first plurality of features from the second plurality of features to form a third plurality of features; generating, by the at least one computing device, a second dataset based on the third plurality of features; running, by the at least one computing device, a plurality of dimensionality reductions on the second dataset to generate a plurality of reduced datasets, where each dimensionality reduction produces a different dimension less than a dimension of the second dataset; calculating, by the at least one computing device, an explained variance (EV) of each of the plurality of reduced datasets to generate a plurality of EVs; identifying, by the at least one computing device, at least one particular EV from the plurality of EVs based on a predetermined EV threshold (EVT); and selecting, by the at least one computing device, a particular reduced dataset from the plurality of the reduced datasets as a target dataset, the particular reduced dataset corresponding to the at least one particular identified EV.

Clause 2. The method according to clause 1, where the deep feature synthesis includes direct features applied over forward relationships.

Clause 3. The method according to any clause above, where the deep feature synthesis includes recursive syntheses of synthesized features.

Clause 4. The method according to any clause above, where each of the plurality of dimensionality reductions projects the second dataset onto a dimensional space with a dimension lower than a dimension of the second dataset.

Clause 5. The method according to any clause above, where the plurality of dimensionality reductions are run with a linear discriminant analysis (LDA) model.

Clause 6. The method according to any clause above, further including sorting the plurality of EVs in a sequential order.

Clause 7. The method according to any clause above, where identifying the at least one particular EV includes a binary search on the plurality of sorted EVs.

Clause 8. The method according to any clause above, where the at least one particular EV is a smallest EV that is above the predetermined EVT.

Clause 9. The method according to any clause above, where the at least one computing device includes a plurality of computing nodes each running one of the plurality of dimensionality reductions.

Clause 10. A system, including: a plurality of processors; and at least one memory storing a plurality of computing instructions configured to instruct at least one of the plurality of processors to: receive a first dataset having a first plurality of features; perform a deep feature synthesis to synthesize a second plurality of features from the first plurality of features; separate the first plurality of features from the second plurality of features to form a third plurality of features; generate a second dataset based on the third plurality of features; run a plurality of dimensionality reductions on the second dataset to generate a plurality of reduced datasets, where each dimensionality reduction produces a different dimension less than a dimension of the second dataset; calculate an explained variance (EV) of each of the plurality of reduced datasets to generate a plurality of EVs; identify at least one particular EV from the plurality of EVs based on a predetermined EV threshold (EVT); and select a particular reduced dataset from the plurality of the reduced datasets as a target dataset, the particular reduced dataset corresponding to the at least one particular identified EV.

Clause 11. The system according to any clause above, where the deep feature synthesis includes and direct features applied over forward relationships.

Clause 12. The system according to any clause above, where the deep feature synthesis includes recursive syntheses of synthesized features.

Clause 13. The system according to any clause above, where each of the plurality of dimensionality reductions projects the second dataset onto a dimensional space with a dimension lower than a dimension of the second dataset.

Clause 14. The system according to any clause above, where the plurality of dimensionality reductions are run with a linear discriminant analysis (LDA) model.

Clause 15. The system according to any clause above, where the plurality of computing instructions are further configured to instruct at least one of the plurality of processors to sort the plurality of EVs in a sequential order.

Clause 16. The system according to any clause above, where identifying the at least one particular EV includes a binary search on the plurality of sorted EVs.

Clause 17. The system according to any clause above, where the at least one particular EV is a smallest EV that is above the predetermined EVT.

Clause 18. The system according to any clause above, where individual one of the plurality of processors runs one of the plurality of dimensionality reductions.

Clause 19. A computer-based method, including: receiving, by at least one computing device, a first dataset having a first plurality of features; performing, by the at least one computing device, a deep feature synthesis to synthesize a second plurality of features from the first plurality of features; separating, by the at least one computing device, the first plurality of features from the second plurality of features to form a third plurality of features; generating, by the at least one computing device, a second dataset based on the third plurality of features; running, by the at least one computing device, a plurality of dimensionality reductions on the second dataset to generate a plurality of reduced datasets, where each dimensionality reduction produces a different dimension less than a dimension of the second dataset; calculating, by the at least one computing device, an explained variance (EV) of each of the plurality of reduced datasets to generate a plurality of EVs; identifying, by the at least one computing device, at least one particular EV from the plurality of EVs that is a smallest EV above a predetermined EV threshold (EVT); and selecting, by the at least one computing device, a particular reduced dataset from the plurality of the reduced datasets as a target dataset, the particular reduced dataset corresponding to the at least one particular identified EV.

Clause 20. The method according to any clause above, where the at least one computing device includes a plurality of computing nodes each running one of the plurality of dimensionality reductions.

While one or more embodiments of the present disclosure have been described, it may be understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

1. A computer-based method, comprising:
receiving, by at least one computing device, a first dataset having a first plurality of features;
performing, by the at least one computing device, a deep feature synthesis to synthesize a second plurality of features from the first plurality of features;
separating, by the at least one computing device, the first plurality of features from the second plurality of features to form a third plurality of features;
generating, by the at least one computing device, a second dataset based on the third plurality of features;
running, by the at least one computing device, a plurality of dimensionality reductions on the second dataset to generate a plurality of reduced datasets, wherein each dimensionality reduction produces a different dimension less than a dimension of the second dataset;
calculating, by the at least one computing device, an explained variance (EV) of each of the plurality of reduced datasets to generate a plurality of EVs;
identifying, by the at least one computing device, at least one particular EV from the plurality of EVs based on a predetermined EV threshold (EVT); and
selecting, by the at least one computing device, a particular reduced dataset from the plurality of the reduced datasets as a target dataset, the particular reduced dataset corresponding to the at least one particular identified EV.

2. The method according to claim 1, wherein the deep feature synthesis comprises utilizing direct features applied over forward relationships.

3. The method according to claim 1, wherein the deep feature synthesis comprises a plurality of recursive syntheses of synthesized features.

4. The method according to claim 1, wherein each of the plurality of dimensionality reductions projects the second dataset onto a dimensional space with a dimension lower than a dimension of the second dataset.

5. The method according to claim 1, wherein the plurality of dimensionality reductions are run with a linear discriminant analysis (LDA) model.

6. The method according to claim 1, further comprising sorting the plurality of EVs in a sequential order.

7. The method according to claim 6, wherein identifying the at least one particular EV comprises a binary search on the plurality of sorted EVs.

8. The method according to claim 1, wherein the at least one particular EV is a smallest EV that is above the predetermined EVT.

9. The method according to claim 1, wherein the at least one computing device comprises a plurality of computing nodes each running one of the plurality of dimensionality reductions.

10. A system, comprising:
a plurality of processors; and
at least one memory storing a plurality of computing instructions configured to instruct at least one of the plurality of processors to:
receive a first dataset having a first plurality of features;
perform a deep feature synthesis to synthesize a second plurality of features from the first plurality of features;
separate the first plurality of features from the second plurality of features to form a third plurality of features;
generate a second dataset based on the third plurality of features;
run a plurality of dimensionality reductions on the second dataset to generate a plurality of reduced datasets, wherein each dimensionality reduction produces a different dimension less than a dimension of the second dataset;
calculate an explained variance (EV) of each of the plurality of reduced datasets to generate a plurality of EVs;
identify at least one particular EV from the plurality of EVs based on a predetermined EV threshold (EVT); and
select a particular reduced dataset from the plurality of the reduced datasets as a target dataset, the particular reduced dataset corresponding to the at least one particular identified EV.

11. The system according to claim 10, wherein the deep feature synthesis comprises direct features applied over forward relationships.

12. The system according to claim 10, wherein the deep feature synthesis comprises recursive syntheses of synthesized features.

13. The system according to claim 10, wherein each of the plurality of dimensionality reductions projects the second dataset onto a dimensional space with a dimension lower than a dimension of the second dataset.

14. The system according to claim 10, wherein the plurality of dimensionality reductions are run with a linear discriminant analysis (LDA) model.

15. The system according to claim 10, wherein the plurality of computing instructions are further configured to instruct at least one of the plurality of processors to sort the plurality of EVs in a sequential order.

16. The system according to claim 15, wherein identifying the at least one particular EV comprises a binary search on the plurality of sorted EVs.

17. The system according to claim 10, wherein the at least one particular EV is a smallest EV that is above the predetermined EVT.

18. The system according to claim 10, wherein individual one of the plurality of processors runs one of the plurality of dimensionality reductions.

19. A computer-based method, comprising:
receiving, by at least one computing device, a first dataset having a first plurality of features;
performing, by the at least one computing device, a deep feature synthesis to synthesize a second plurality of features from the first plurality of features;
separating, by the at least one computing device, the first plurality of features from the second plurality of features to form a third plurality of features;
generating, by the at least one computing device, a second dataset based on the third plurality of features;
running, by the at least one computing device, a plurality of dimensionality reductions on the second dataset to generate a plurality of reduced datasets, wherein each dimensionality reduction produces a different dimension less than a dimension of the second dataset;
calculating, by the at least one computing device, an explained variance (EV) of each of the plurality of reduced datasets to generate a plurality of EVs;
identifying, by the at least one computing device, at least one particular EV from the plurality of EVs that is a smallest EV above a predetermined EV threshold (EVT); and
selecting, by the at least one computing device, a particular reduced dataset from the plurality of the reduced datasets as a target dataset, the particular reduced dataset corresponding to the at least one particular identified EV.

20. The method according to claim 19, wherein the at least one computing device comprises a plurality of computing nodes each running one of the plurality of dimensionality reductions.
